(19) United States
(12) Patent Application Publication
(10) Pub. No.: US 2016/0131785 A1
(43) Pub. Date: May 12, 2016

(54) METHOD AND SYSTEM FOR MARINE SEISMIC ACQUISITION

(71) Applicant: CGG SERVICES SA, Massy Cedex (FR)

(72) Inventor: Hélène TONCHIA, Antony (FR)

(73) Assignee: CGG SERVICES SA, Massy Cedex (FR)

(21) Appl. No.: 14/893,282

(22) PCT Filed: Jun. 6, 2014
(86) PCT No.: PCT/EP2014/061914

§ 371 Date: Nov. 23, 2015

Related U.S. Application Data
(60) Provisional application No. 61/832,511, filed on Jun. 7, 2013.

(51) Int. Cl. G01V 1/38

(52) U.S. Cl. CPC G01V 1/3808

(57) ABSTRACT

A seismic acquisition system includes a streamer spread including at least one streamer, the streamer spread having first and second spread areas characterized by at least one acquisition parameter, the first spread area including streamer sections having a first composition of seismic receivers, and the second spread area including streamer sections having a second composition of seismic receivers. The first composition of seismic receivers has a first value for the at least one acquisition parameter and the second composition of seismic receivers has a second value for the at least one acquisition parameter.

### BACKGROUND

1. Technical Field

Embodiments of the subject matter disclosed herein generally relate to methods and systems and, more particularly, to mechanisms and techniques for configuring multi-component streamers to achieve desired seismic data characteristics suitable for one or more of deghosting, high-frequency, low-frequency, interpolation, etc.

2. Discussion of the Background

Reflection seismology is a method of geophysical exploration to determine the properties of a portion of the earth's subsurface, information that is especially helpful in the oil and gas industry. Marine reflection seismology is based on the use of a controlled source that sends energy waves into the earth. By measuring the time it takes for the reflections to come back to plural receivers, it is possible to estimate the depth and/or composition of the features causing such reflections. These features may be associated with subterranean hydrocarbon deposits.

For marine applications, a seismic survey system 100, as illustrated in FIG. 1, includes a vessel 102 that tows plural streamers 110 (only one is visible in the figure) and a seismic source 130. Streamer 110 is attached through a lead-in cable (or other cables) 112 to vessel 102, while source array 130 is attached through an umbilical 132 to the vessel. A head float 114, which floats at the water surface 104, is connected through a cable 116 to a head end 110A of streamer 110, while a tail buoy 118 is connected, through a similar cable 116, to a tail end 1108 of streamer 110. Head float 114 and tail buoy 118 are used, among other things, to maintain the streamer's depth. Seismic receivers 122 are distributed along the streamer and are configured to record seismic data. Seismic receivers 122 may include a hydrophone, geophone, accelerometer, gradient pressure receiver or a combination thereof. Positioning devices (birds) 128 are attached along the streamer and controlled by a controller 126 for adjusting a position of the streamer according to a survey plan.

Source array 130 has plural source elements 136, which typically are air guns. The source elements are attached to a float 137 to travel at desired depths below the water surface 104. During operation, vessel 102 follows a predetermined path T while source elements 136 emit seismic waves 140. These waves bounce off the ocean bottom 142 and other layer interfaces below the ocean bottom 142 and propagate as reflected/refracted waves 144 that are recorded by receivers 122. The positions of both the source element 136 and recording receiver 122 are estimated based on GPS systems 124 and recorded together with the seismic data in a storage device 127 onboard the vessel. Controller 126 has access to the seismic data and may be used to achieve quality control or even full processing of this data. Controller 126 may be also connected to the vessel's navigation system and other elements of the seismic survey system, e.g., birds 128.

The recorded seismic data is later processed to achieve one or more objectives. For example, in a 3D seismic survey, it may be desirable to achieve ghost diversity so that the notches formed by the ghosts in the frequency spectrum can be filled in. To achieve good deghosting, as disclosed in U.S. Pat. No. 8,593,904, authored by Soubaras and assigned to the assignee of this application (the entire content of which is incorporated by reference), it is possible to shape the streamer to have a curved profile. Depending on the interest in the low frequency content or the high frequency content, the depth of the streamer and the receiver composition may also be adapted to maximize the quality of the seismic data. In this respect, it is known that for a depth imaging of the Earth, the low-frequencies are desirable as they travel a long distance. On the contrary, the high-frequencies are quickly attenuated by the Earth, and thus, they are more appropriate for shallow imagining. However, the high frequencies generated a finer definition of the surveyed surbsurface. For example, the high-frequency data may include frequencies between 100 and 250 Hz and the low-frequency data may include frequencies lower than 35 Hz.

However, for a site survey, the goal is to provide a more detailed image and representation of the geology closer to the seabed, e.g., in the range of a few hundred meters from the seabed. This type of survey may be used to assess the suitability of an area for a platform installation. If a broadband survey is also performed for the same subsurface, it may provide a description of the deeper part of the subsurface, for reservoir assessment, using the low frequencies as well as a detailed one of the shallower part.

Many techniques are currently available for broadband surveys. Such survey may involve the streamer's shape (e.g., BroadSeis configuration, owned by the assignee of this application), over-under configurations (in which some streamers are located beneath other streamers to have different depths), slant streamer, multi-sensor streamers, broadband sources (e.g., multi-levels sources), different arrays with different depths, non air gun sources like sparkers for higher frequencies, etc.

For a 4D survey, which has the purpose of imagining changes over time of a same subsurface (e.g., for reservoir monitoring), it is best if the shot points of the source array or arrays and the locations of the seismic receivers are precisely repeated in time.

Further, for some surveys it is desired to have selected sections of the streamer (usually those closed to the vessel) record both pressure and particle motion data while for others sections, closer to the end of the streamer, it is desired to record only pressure data.

Thus, it can be seen from the limited number of examples provided above, that each type of survey requires different streamer arrangements and/or configurations. In other words, it is not possible to have all types of sections in a large number on the seismic vessel. Further, even if the equipment storage will not be a limitation, the more sensors there are in a streamer, the more data are acquired. Depending on the frequency, the area of interest, the depth, the geology, not all the data is necessary during processing. Thus, if a vessel were to acquire high density data, with a high number of sensors and with a high frequency, it will result in a large amount of data, which is too much for the current acquisition equipment. In addition, a large part of that data would not be used, but rather dropped by processing.

However, because the space is limited on the back of the vessel carrying the seismic survey equipment, and because not all of the acquired seismic data may be needed during processing, it is impractical to store streamers that have only hydrophones, and streamers that have both hydrophones and particle motion receivers, and streamers that have only particle motion receivers, etc. and also to record all the data associated with these streamers.

Thus, there is a need to have a streamer whose configuration can easily be changed/adjusted, from seismic survey to seismic survey, that does not require large equipment and data storage capabilities, and that is capable to achieve one or more of the configurations discussed above.

### SUMMARY

According to one embodiment, there is a seismic acquisition system that includes a streamer spread including at least one streamer, the streamer spread having first and second spread areas characterized by at least one acquisition parameter. The first spread area includes streamer sections having a first composition of seismic receivers, and the second spread area includes streamer sections having a second composition of seismic receivers. The first composition of seismic receivers has a first value for the at least one acquisition parameter and the second composition of seismic receivers has a second value for the at least one acquisition parameter.

According to another embodiment, there is a seismic acquisition system that includes a vessel and a streamer spread towed by the vessel and including at least one streamer, the streamer spread having first and second spread areas characterized by at least one acquisition parameter. The first spread area includes streamer sections having a first composition of seismic receivers, and the second spread area includes streamer sections having a second composition of seismic receivers. The first composition of seismic receivers has a first value for the at least one acquisition parameter and the second composition of seismic receivers has a second value for the at least one acquisition parameter.

According to another embodiment, there is a method for acquiring seismic data. The method includes defining a first spread area of a streamer spread including at least one streamer, wherein the first spread area is characterized by at least one acquisition parameter having a first value; defining a second spread area of the streamer spread, wherein the second spread area is characterized by the at least one acquisition parameter having a second value; selecting streamer sections having a first composition of seismic receivers for the first spread area and streamer sections having a second composition of seismic receivers for the second spread area based on a corresponding value of the at least one acquisition parameter; generating seismic waves; and recording with the first and second composition of seismic receivers seismic data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a seismic acquisition system;

FIG. 2 is a schematic diagram of a streamer spread having various spread areas with different receiver configurations and/or compositions;

FIGS. 3A-C illustrate streamer spreads having spread areas with different shapes;

FIG. 4 illustrates a Fresnel zone;

FIG. 5 is a flowchart of a method for configuring a seismic spread in for seismic data acquisition;

FIG. 6 illustrates plural spread areas that extend across plural streamer spreads that are towed along parallel paths.

FIG. 7 illustrates plural spread areas that extend across plural streamer spreads that are towed along a same path.

FIG. 8 illustrates a streamer spread having at least one streamer that includes sections with no seismic receivers;

FIGS. 9A-B illustrate a seismic source array including a multi-level source array and one or more high-frequency source arrays;

FIG. 10 illustrates a variation of the seismic source of FIGS. 9A-B;

FIG. 11 illustrates tilted source elements for the high-frequency source array;

FIG. 12 illustrates a seismic source having the high-frequency source array located outside the multi-level source array;

FIGS. 13A and 13B illustrate cross-sections view of source arrays;

FIG. 14 illustrates a source array having the high-frequency source closer to a towing vessel than a multi-level source array;

FIG. 15 is a flowchart of a method for processing seismic data; and

FIG. 16 is a schematic diagram of a control device.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a streamer towed in water by a vessel. However, the embodiments to be discussed next are not limited to a marine streamer; they may be applied to other seismic elements that need to be flexible for accommodating various configurations.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a seismic acquisition system that includes a streamer spread including at least one streamer. The streamer spread has at least first and second spread areas characterized by at least one acquisition parameter. The first spread area includes streamer sections having a first composition of seismic receivers. The second spread area includes streamer sections having a second composition of seismic receivers, different from the first composition. The first spread area has a first value for the at least one acquisition parameter and the second spread area has a second value for the at least one acquisition parameter. In one application, if multiple acquisition parameters are used, two or more of the acquisition parameters have different values from spread area to spread area.

Examples of the at least one acquisition parameter include one or more of a configuration of the seismic sensors in a corresponding area, a depth profile of the seismic sensors in a corresponding area, a type of seismic survey acquisition in a corresponding area, a spatial density of the seismic receivers in a corresponding area, an offset of the seismic sensors in a corresponding area relative to a towing vessel, or a status of the seismic sensors in a corresponding area. These acquisition parameters are now discussed in more detail.

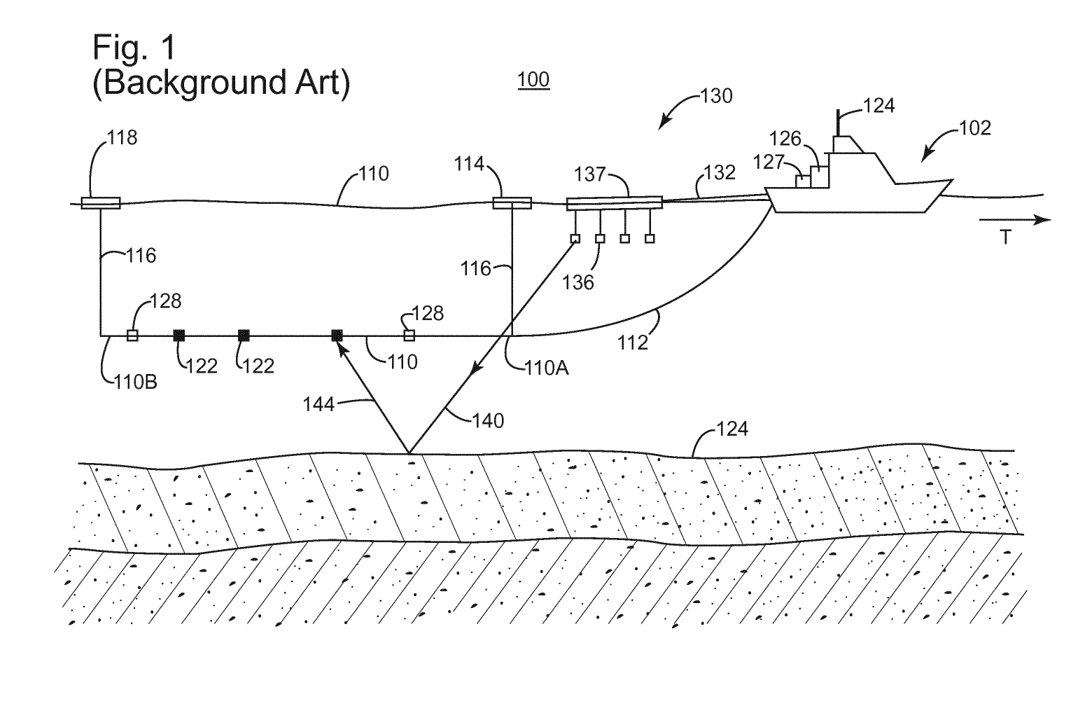

According to an embodiment, there is a seismic marine acquisition system 200 that includes a towing vessel 202 that tows a streamer spread 203 that includes at least one streamer 204. Although this embodiment is exemplified with plural streamers, those skilled in the art would recognize that the system also works with a single streamer. Streamers 204 may have any lengths, for example, from 2 to 20 km. Other values are possible depending on the type of the seismic survey. Streamers 204, as previously discussed with reference to FIG. 1, may include birds 206 for positioning and/or steering the streamer. According to this embodiment, seismic receivers are distributed along sections of the streamer according to predetermined areas. Regarding a streamer section, note that a streamer is made out of plural sections. A section is a physical unit, not an arbitrary part of the streamer. In other words, each section has physical ends configured to connect to other ends of other sections to make up the streamer. In one application, all the sections have the same lengths, but they may have different configurations and/or compositions (i.e., acquisition parameters) in terms of the seismic receivers present inside them. The term “composition” is used herein to mean the type of sensors used in a given section while the term “configuration” is used herein to mean the physical arrangement (e.g., distance) of the seismic sensors. These concepts are exemplified next.

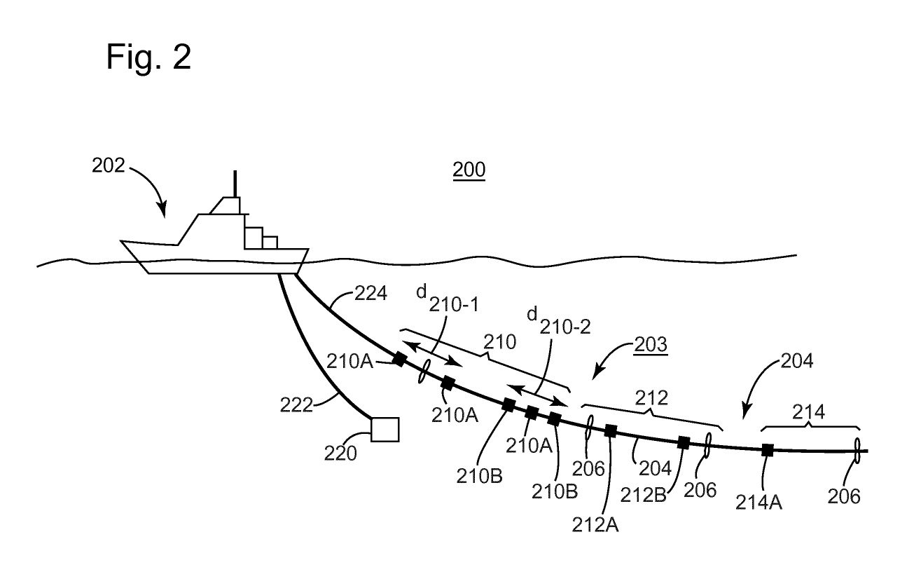

For example, FIG. 2 shows three spread areas 210, 212 and 214 that extend along one or more streamers 204. Note that the term spread includes all the streamers and associated elements and/or the seismic source array 220 and associated umbilical 222 (i.e., the cables connecting the source array to the vessel). The spread may also include the lead-in cables 224 connecting the streamers to the vessel.

Each spread area may include a specific receiver configuration and/or composition as now discussed. Note that a spread area may refer to a single streamer or plural streamers. For example, spread area 210 may include sections having pressure receivers 210A and particle motion receivers 210B. An example of a pressure receiver is a hydrophone while an example of a particle motion receiver is an accelerometer. A composition of this spread area includes pressure and particle motion receivers. A composition may include only pressure receivers or only particle motion receivers. A configuration of spread area 210 is related to the distribution (e.g., distance) between the receivers. For example, pressure receivers 210A may be distributed along sections of streamers 204, within spread area 210, with a distance d₂₁₀₋₁ while particle motion receivers 210B may be distributed along sections of streamers 204, within spread area 210, with a distance d₂₁₀₋₂. For example, distance d₂₁₀₋₁ may be 3.125, or 6.25 or 12.5 m while distance d₂₁₀₋₂ may be around 1 m. Any other numbers may be used depending on the characteristics of the surveyed area and the purpose of the seismic survey.

Another spread area 212 may also include pressure receivers 212A and particle motion receivers 212B, but distributed with different distances d₂₁₂₋₁ and d₂₁₂₋₂ within spread area 212, different from spread area 210. In one embodiment, spread area 212 may include only pressure receivers 212A or only particle motion receivers 212B.

A third spread area 214 may also include pressure receivers 214A and particle motion receivers (not shown), also distributed with different distances d₂₁₄₋₁ and d₂₁₄₋₂ from the first and second spread areas. In one application, spread area 214 includes only one type of receiver. In another application, spread area 214 includes only pressure receivers 214A as illustrated in FIG. 2. The configuration (i.e., distances) of the first spread may be different or the same as the configuration of the third spread. In one embodiment, only two spread areas are present. In another embodiment, more than two spread areas are selected.

In another embodiment, spread area 212 includes sections of the same type or composition as spread area 210 or spread area 214. In still another embodiment, there are only two spread areas, e.g., 210 and 212. On the first spread area 210, only sections of a first type/composition are used while on the second spread area 212, the sections can be of the first type/composition or the second type/composition. In one application, there is at least one section of the second type/composition in the second spread area 212.

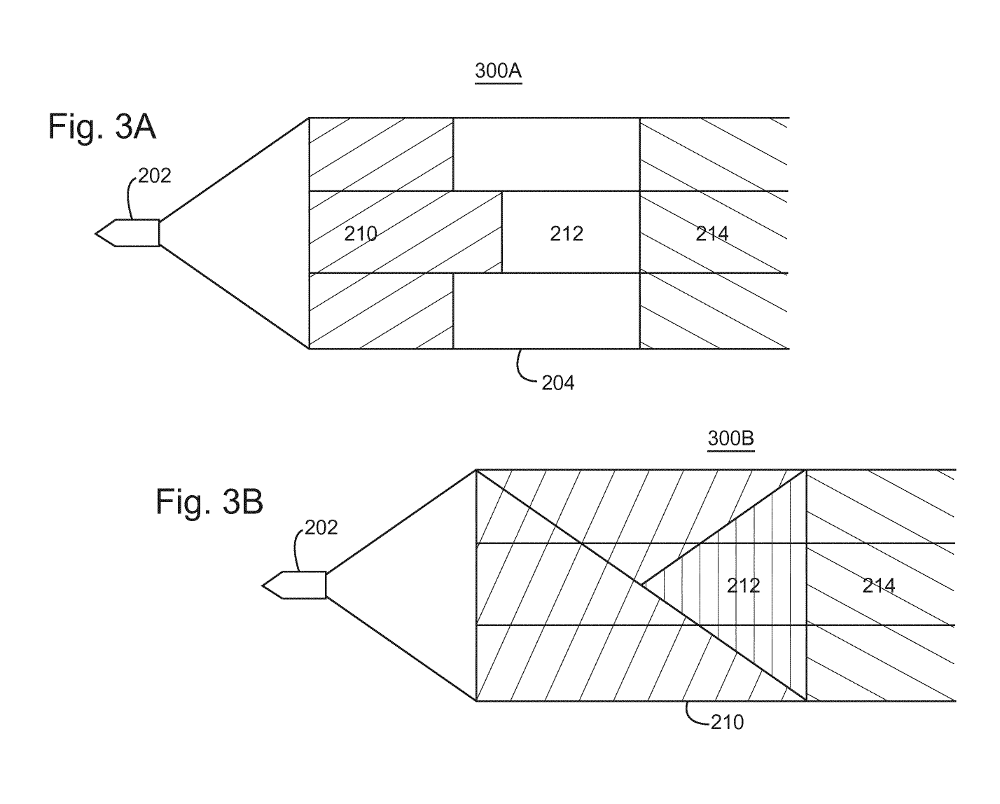

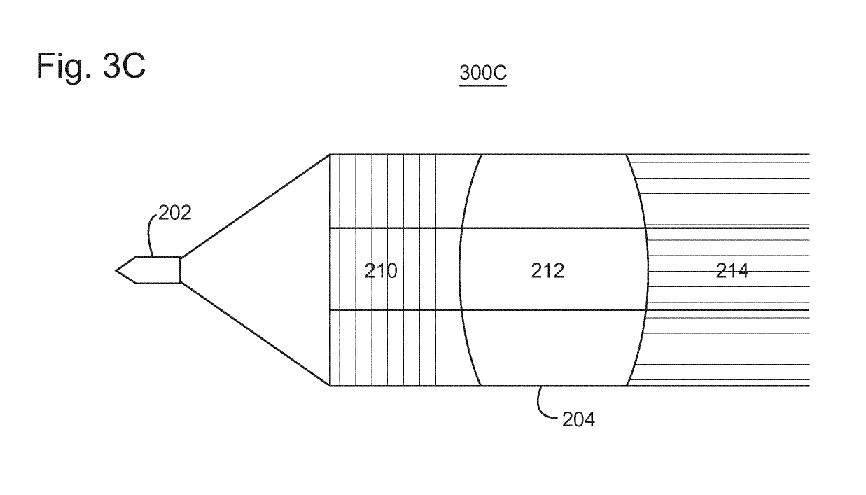

FIGS. 3A-B are bird views of spread areas 210, 212 and 214 discussed above, with both figures showing that spread areas do not have to be squares or rectangles. Spread areas 210, 212 and 214 may take any shape as determined by the operator of the survey. In this regard, FIG. 3C shows spread areas having not only straight line sides, but also curved sides. Any combination of shapes is possible for the spread areas. Also, any number larger than two is possible for the spread areas. Any two spread areas may have (i) same configuration and same composition, or (ii) same configuration and different compositions or (iii) different configurations and same compositions, or (iv) different configurations and different compositions. In one embodiment, the shape of one or more spread areas is changed from shot to shot. This may be possible if one or more acquisition parameters are changed for the one or more spread areas.

Note that the above discussed spreads and spread areas were discussed for streamers having variable-depth profiles, i.e., at least one of spread area has the corresponding seismic receivers distributed at different depths one from the other. In one embodiment, two or more sections have the receivers distributed at different depths (which is another acquisition parameter).

The different receiver depths ensure ghost diversity, which is useful for deghosting. The different receiver configurations and/or compositions, i.e., the mixed streamers having more receivers (high-density receivers, which is another acquisition parameter) in the sections closer to the source array are advantageous for improving the resolution in the short offset (close to the source array) sections. However, increasing the number of receivers distributed in the sections increases the manufacturing price of the streamer and also the amount of data that needs to be transmitted from the receivers to the vessel. To limit these disadvantages, only the streamer sections in dedicated spread areas, for example, those closer to the vessel, would have the high-density receivers while the other streamer sections would have low-density receivers.

Thus, in one application, the first spread area has streamer sections that are better adapted for high-frequency data recording. In another application, the first spread area has streamer sections having a higher density of hydrophones than the second spread area for better resolution. The first spread area may correspond to the most shallower streamer sections. In another application, the first spread area includes streamer sections that include multi-component receivers and these sections are shallower than the remaining sections. In one application, the second spread area includes streamer sections having a lower density of hydrophones and/or lower density of multi-component receivers.

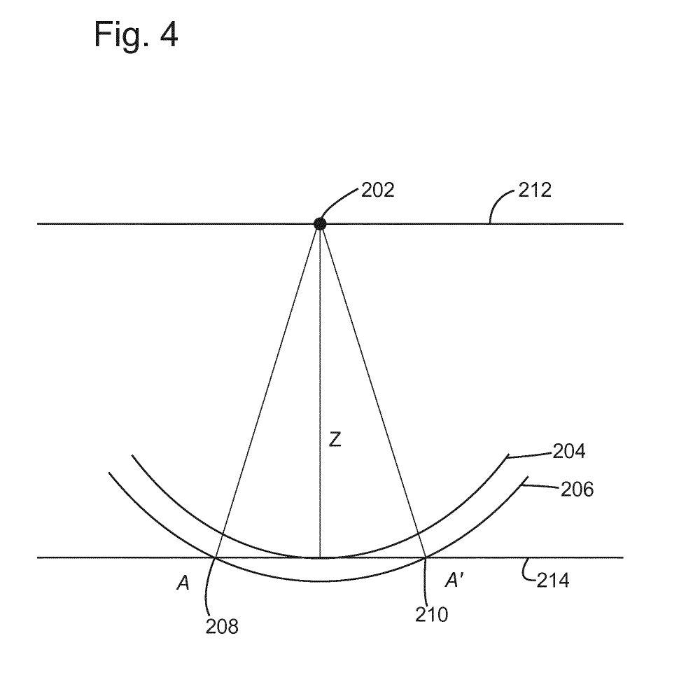

In one application, the depths (another acquisition parameter) at which the streamer sections of the first spread area are towed are selected to optimize the medium to high frequency content of the recorded data set. In one embodiment, one or several of the attributes of each position in the spread is used to determine the spread area. For example, the attribute may be the depth, or the offset (i.e., the distance between the receiver and the vessel or the source arrays), or a combination of those. In one application, the spread areas are defined based on the Fresnel zone sizes (another acquisition parameters) of the traces of the streamer sections within the corresponding spread area. The Fresnel zone is defined, as illustrated in FIG. 4, by locations 208 and 210 where a second wave-front 206 intersects reflector 214. Wave-front 206 is obtained by considering a source 202 at or near the water surface 212, and source 202 emits a wave that propagates toward the reflector. A first wave-front 204 reaches (i.e., the reflector is tangent to the first wave-front) the reflector 214 and the second wave-front 206 propagates one fourth of the wavelength of the wave away from the first wave-front 204. Thus, based on this definition of the Fresnel zone, the reflected signal is a result of the property of the reflector within the Fresnel zone bounded at reflector locations “A” 208 and “A′” 210. It should be noted that a reflection thought of as coming back to the surface from a point is actually being reflected from an area having the dimension of the Fresnel zone.

In one application, the first spread area is chosen to provide an improved acquisition, for example, higher frequency or better signal-to-noise ratio or better interpolation quality, or better deghosting (all these parameters are examples of acquisition parameters) or any other attributes of the seismic dataset than other spread areas. Because of these reasons, the shape of the spread areas may vary in various ways.

According to another embodiment, it may not be necessary to have a high sampling rate (another acquisition parameter) on all the data as different frequency contents may be desired for different sections of the streamers and/or spread areas. Note that sampling rate refers herein to a temporal sampling rate, i.e., at the temporal sampling of the signal on a seismic sensor, which is performed by a digitizer unit. For example, for the embodiment illustrated in FIG. 2, it may be the case that the third spread area is responsible only for low-frequency content and the first spread area is responsible only for the high-frequency content. For this case, the acquisition system may be configured to have a high sampling rate for the streamer sections of the first spread area and a low sampling rate for the streamer sections of the third spread area. In one application, each spread area may have its own sampling rate. The sampling rates of any two spread areas may be different. In one application, some of the sampling rates may be the same for different spread areas. In one application, the sampling rate, configuration and/or composition for different spread areas may be mixed in any desirable way.

Thus, a seismic acquisition system may include one or more streamers, and at least one streamer may have a section that is sampled with a first sampling rate and a second section that is sampled with a second sampling rate, different from the first sampling rate. The different sampling rates may also be associated with the spread areas instead of the streamer sections. In one application, the sampling rates are associated with the depths of the seismic receivers.

In one application, the sampling rate may be adapted to the acquired frequency content. In another application, the first sampling rate is higher for some of the shallower sections than those of the deeper sections.

In one embodiment, for achieving greater flexibility for the possible configurations and/or compositions of the seismic receivers, it is possible to disable desired receivers (i.e., the status of the receiver is another example of an acquisition parameter). In this way, an effective density (e.g., composition) of the seismic receivers may be controlled, which is beneficial for avoiding large amount of seismic data transiting along the streamer. In one application, it may be of interest to disable the recording of some of the receivers from one or more sections. In one application, it is possible to control which receivers are disabled so that the receivers are disabled in a random way. By disabling selected receivers, it is possible to define a new combination and number of receivers for one or more streamer sections or for one or more spread areas. Note that disabling selected receivers may be implemented in software and/or hardware. For example, a controller associated with a data processing module distributed on the streamer and configured to receive the recorded data from the receivers may be instructed to simply delete the recordings received from selected receivers. As in the previous embodiments, this capability of disabling receivers may be implemented in streamers having a variable-depth profile. In one application, some of the pressure receivers are disabled in one or more of the deeper streamer sections and/or spread areas. In another application, some of the particle motion receivers are disabled in one or more of the deeper streamer sections and/or spread areas. Any desired combination of receivers may be selected to be disabled.

According to another embodiment, depending on what one survey intends to achieve, it may be preferable to have more data, higher spatial density of receivers (another example of an acquisition parameter), deeper streamers or shallower streamers, deeper sources or shallower sources, hydrophone data or geophone data or multicomponent data, high-frequency data or low-frequency data, short-offset data or long-offset data, inline data or cross-line data, quicker processing flow, less data on the streamer lines, one type of deghosting or another (all of these are also examples of the acquisition parameter). To achieve one or more of the above noted types of data, it is possible to define different areas in the acquisition system, the spread areas discussed above with reference to FIGS. 2 to 3C, where different types of data or different combination of data or different density of data or different sampling rate of data are to be acquired.

According to this embodiment, the seismic operator has to choose one or more type of streamer sections or different combination of receivers in the sections and different depths and different sampling rates and different frequency ranges, and different filters and beam forming for the receivers in the sections to optimize the acquisition and to achieve the desired seismic data, i.e., the operator has to choose the set of acquisition parameters that need to be implemented. In one application, the composition of the seismic receivers and one more acquisition parameters are used for selected the spread areas. While all of the above embodiments have been discussed with regard to streamers and spread areas, those skilled in the art would recognize that these embodiments are equally applicable to ocean bottom cables (OBC), i.e., acquisition systems that are distributed on the ocean bottom. The OBC are stationary, i.e., they are not towed by a vessel.

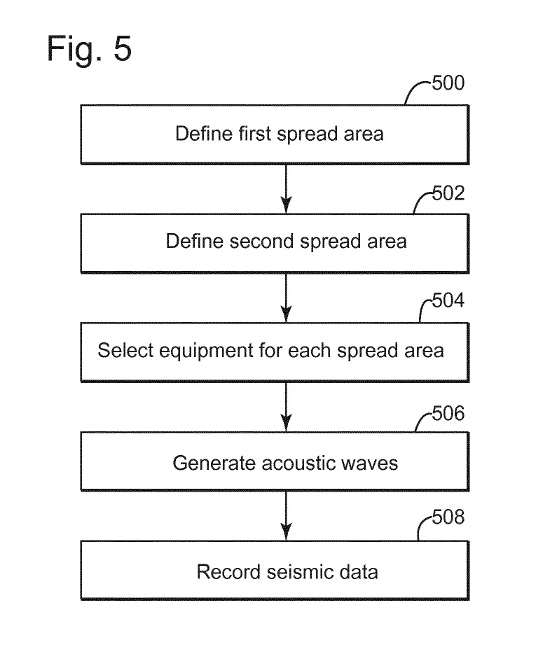

According to an acquisition method illustrated in FIG. 5, step 500 includes defining at least a first spread area where a first type of data is preferably acquired, and step 502 includes defining a second spread area, different from the first spread area, where at least a second type of data is expected to be acquired. Both steps define the spread areas based on the selected acquisition parameters. Then, in step 504, the different pieces of acquisition equipment, like the streamer sections, are arranged (assembled together to form the streamers) according to the first and second spread areas defined above. Note that the streamer manufacturers are producing these types of streamer sections that can be easily connected to each other on the back of the deck. In this regard, note that it is possible that at least a first piece of acquisition equipment (e.g., a section) is better adapted to acquire the first type of data and at least a second piece of acquisition equipment, which is different from the first piece or configured differently from the first piece, is not so well adapted to acquire the first type of data. Alternatively, if the streamer sections have all the necessary receivers inside, the streamer sections may be electronically programmed to disable targeted receivers to achieve the configurations and/or compositions assigned to the various spread areas, i.e., the manufacturers may build streamer sections that have all possible configurations and compositions already built in and the operator just selects the desired one by disabling the extra receivers. The method further includes a step 506 of generating acoustic waves using a source array and a step 508 of recording the data with the different pieces of acquisition equipment.

The different pieces of acquisition equipment may be arranged in a towed array of seismic streamers. In one application, each streamer section or spread area is given a target depth (i.e., they have different depths). In one application, the first spread area is defined as being the area where the streamer section target depth is above a first depth. In another application, the target depth in the first area is increasing when a distance from the head of the streamer is increasing. In one application, the streamer portions in the first area have a curved depth profile while being towed underwater, the curved profile being a parabola, a circle or a hyperbola. In one application, the streamer portions in the first area have a slanted depth profile while being towed underwater with depth being a linear function of the distance to a given point (for example, the head of the streamer, or the point where the streamer enters the first spread area, or the vessel, or the source). The distance can be measured as a straight distance along the streamer.

In another embodiment, different types of acquisition (another example of acquisition parameter) may be acquired during a single seismic survey. For example, in the past, there were several types of surveys depending whether one wanted high resolution, shallow penetration survey (e.g., to install a platform, i.e., a site survey), to map the medium depth or under a salt dome or any other complex geology.

With the advance of broadband techniques it is now possible to combine several types of survey in one. For example, assume that it is desired to record two different surveys, (1) a site survey (shallow penetration survey to install a platform) and (2) a standard 3D survey for a target that is 3 s deep (in terms of the time needed for the seismic signal to propagate from the source to the target). The site survey needs to acquire high frequencies on the shallow part of the subsurface, for which only the near offsets are useful, preferably with a higher fold (number of data per cell) to increase the signal-to-noise ratio. A site survey is traditionally performed with smaller sources, and possibly with a higher sampling rate of the data and possibly with a higher density of sensors, inline and/or cross-line while for the 3D survey, longer streamers, to record the reflection of the target, and lower frequencies emitted by the source may be necessary.

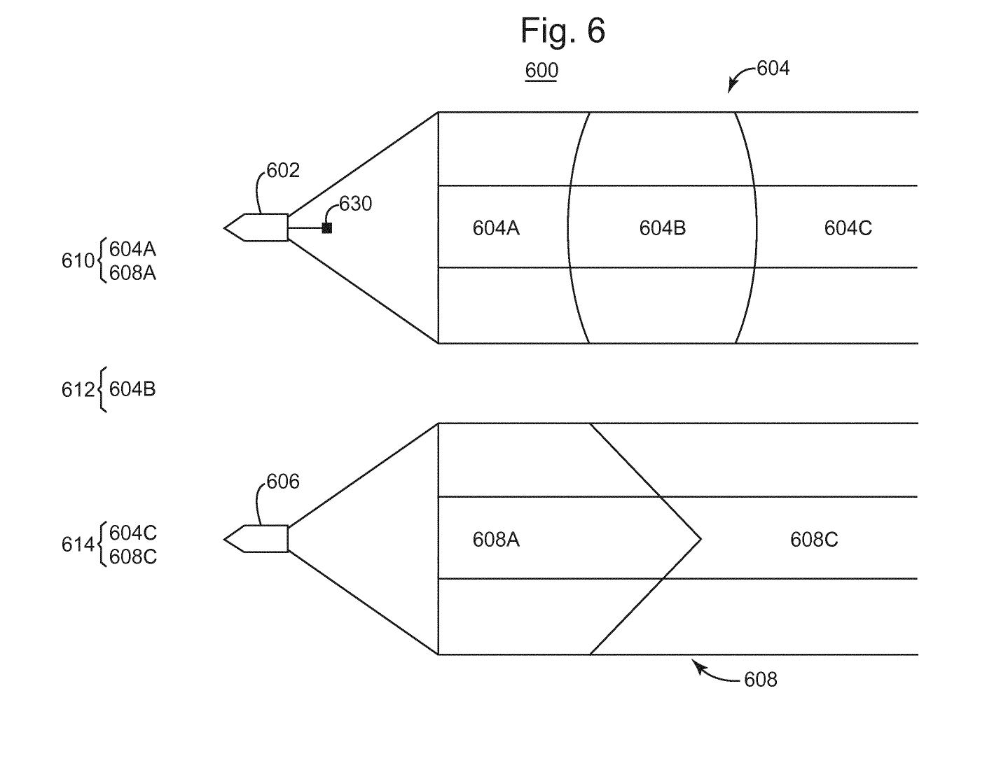

By using the embodiments discussed above, it is possible to define one or more first spread areas for the 3D survey and one or more second spread areas for the site survey. Alternatively, more than one tow vessel and spread may be used for achieving the various surveys. According to an application illustrated in FIG. 6, a seismic survey system 600 may include a seismic source 630, a first tow vessel 602 towing a first spread 604 to acquire seismic data and a second tow vessel 606 towing a second spread 608 (the second tow vessel can be the same as the first one or a different one) to also acquire seismic data. A first spread area 610 may be defined to include streamer sections (or spread areas 604A and 608A) from both spreads 604 and 608, second spread area 612 may be defined to include streamer sections (or spread area 604B) only from one spread (i.e., 604) and third spread area 614 may be defined to include streamer sections (or spread areas 604C and 608C) from both spreads 604 and 608.

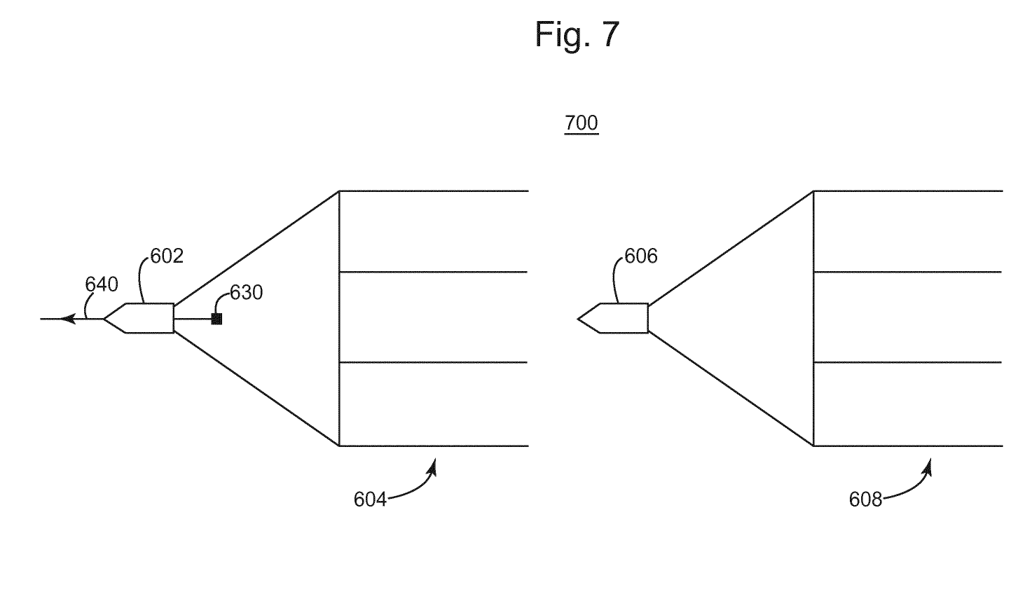

Under another scenario illustrated in FIG. 7, the second tow vessel 606 follows the first tow vessel 602 along a same travel path 640 (or substantially in parallel along travel path 640) and the first tow vessel 602 acquires at least short offset data from the first source 630 with a first part of its spread 604 while the second tow vessel 606 acquires at least long offset data from the first source 630 with a first part of its spread 608. The first part of the first spread 604 may be operated with a first set of acquisition parameters and the first part of the second spread 608 may be operated with a different set of acquisition parameters.

In one application, the first set of acquisition parameters includes acquiring hydrophone data with a certain spatial density or distribution in the spread or different number of receivers per section and the second set of acquisition parameters includes acquiring hydrophone data with a different spatial density or distribution in the spread or a different number of receivers per section. In another application, the first set of acquisition parameters includes using hydrophones and/or multi-component receivers and/or particle motion receivers with a first given sampling rate and the second set of acquisition parameters includes using hydrophones and/or multicomponent receivers and/or particle motion receivers with either a second given sampling rate, different from the first one, or with a different number or a different combination of receivers or a different distribution of receivers in the spread than the first one.

In one application, the first sampling rate is higher than the second one and the density of the hydrophone data acquired with the first set of acquisition parameters is higher than that of the second set. In still another application, the first set of acquisition parameters includes using hydrophones and/or multicomponent receivers and/or particle motion data and the second set of acquisition parameters includes using hydrophones and/or multicomponent receivers and/or particle motion data with a different number of receivers per sections or combination or distribution than the first set.

In still another application, the first tow vessel acquires data which is not short offset from the first source, a second part of its spread different from the first part, and with a third set of acquisition parameters different from the first set, but that could be the same as the second set. In one application, the streamers in one of the spread or in one of the parts of one of the spreads are towed with different variable depths. For all the embodiments discussed herein, the seismic source may be a broadband source, for example a multi-level source. More than one source or source array may be used with the above discussed embodiments. For example, in one application, a second source array, close to the first part of the first spread, may be used and the first source array is tuned for high frequency and/or low output and/or low penetration to provide high frequencies to the first part of the first spread. The second source array may be shot in between the shooting points of the first source array, without changing the first source array's shooting rate. In one application, the second source array is shot with a given absolute delay relative to the first source array.

In one embodiment, the distribution of one or several of the receivers is random or pseudo-random in the first part of the first spread. In another embodiment, the second source array may be made from spare guns from the first source array, or guns towed on the same structure as the first source array, but not fired within the first source array so that these guns are filled with air when it is time to shoot the second source array. In one application, the second source array is not far from the first source array so as to illuminate in between the first source array common middle point (CMP) lines.

The seismic data recorded based on one or more of the methods discussed above may be redatumed to a chosen depth. Then, the hydrophone and/or multi-component receiver and/or particle motion data may be interpolated at a desired datum so that a 4D comparison of the traces may be performed with higher accuracy.

In another embodiment, it is possible to select a receiver distribution in the various spread areas of a given streamer spread so that, during a seismic acquisition survey, a recorded seismic dataset includes first and second sub-datasets. The first sub-dataset may be acquired with a first set of receivers including different types of receivers, e.g., hydrophones and at least another type of receiver like, pressure gradient receivers and/or particle motion receivers and/or multi-component receiver. The second sub-dataset may be acquired with a second set of receivers, different from the first set of receivers, in the density, configuration or composition, the second set of receivers including, for example, hydrophones. The seismic data may be acquired with streamers partially having a curved profile.

The acquired hydrophone data may be processed for the entire dataset to generate a first processed dataset while the second sub-dataset may be processed to generate a higher density second processed data set. In one application, the first sparse processed dataset may be merged with the second processed data set to obtain an enhanced dataset.

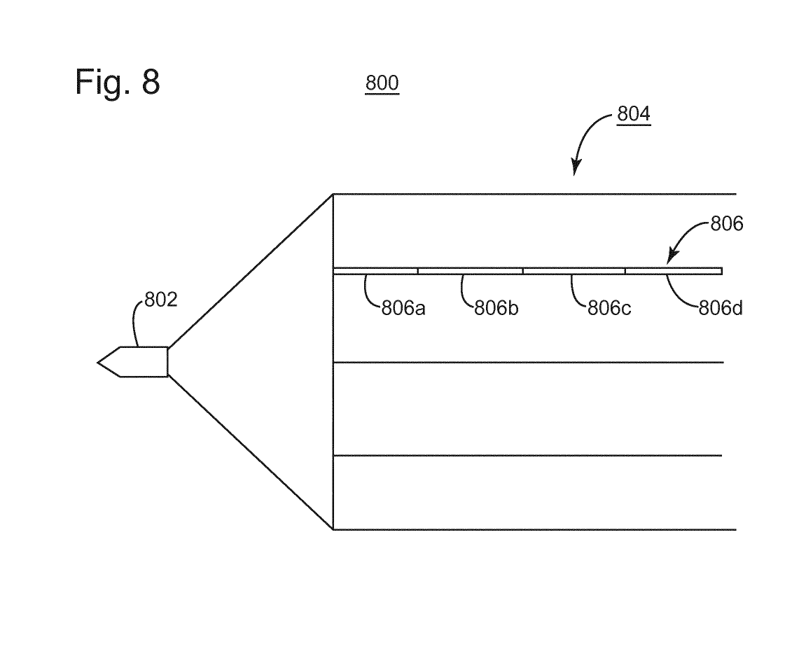

In one application, as illustrated in FIG. 8, a seismic acquisition system 800 may include a vessel 802 that tows a streamer spread 804. Streamer spread 804 includes at least a streamer 806. Streamer 806 may include plural sections 806a-d (four sections are shown for simplicity, but any number of sections may be used). In one application, some of the sections, e.g., 806a and 806b are shorter than the other sections of streamer and these sections may include one or more multi-component receivers and/or one or more hydrophones and/or one or more particle motion receivers and/or one or more pressure gradient receivers. In the same configuration, it is possible to have one or more sections 806c with no seismic receivers at all. In one application, one or more sections are short and include any number of receivers and a given number of sections 806c with no receivers are added to make a streamer with a flexible distribution of each receiver. Note that a streamer section is a physical section that has at its ends two respective connectors for connecting to adjacent sections. In other words, a streamer section is not an arbitrary part of a streamer, but a well defined part that has connecting ends attached to the section during the manufacturing process.

For example, it is possible to have a streamer section 806a only having hydrophones with a high density, e.g., one hydrophone every 1.5 meters and thus, a streamer made of only this type of sections achieves a high density streamer. It is also possible to have one hydrophone section followed by a particle motion receiver section. Other configuration and/or combinations are contemplated.

In this way, it is possible to produce sections with a variable density of receivers, e.g., hydrophones, for example high density in the short offset and sparse in the longer offset. In one application, it is possible to even have a random or pseudo-random distribution of receivers, which may improve some type of interpolation. Thus, a streamer can be composed of a first hydrophone section 806a followed by a multi-component receiver section 806b followed by an empty section 806c that has no seismic receiver at all, followed again by a hydrophone section 806d and so on. In one application, the length of the empty section 808c may be increasing along the streamer as it gets farther apart from the towing vessel.

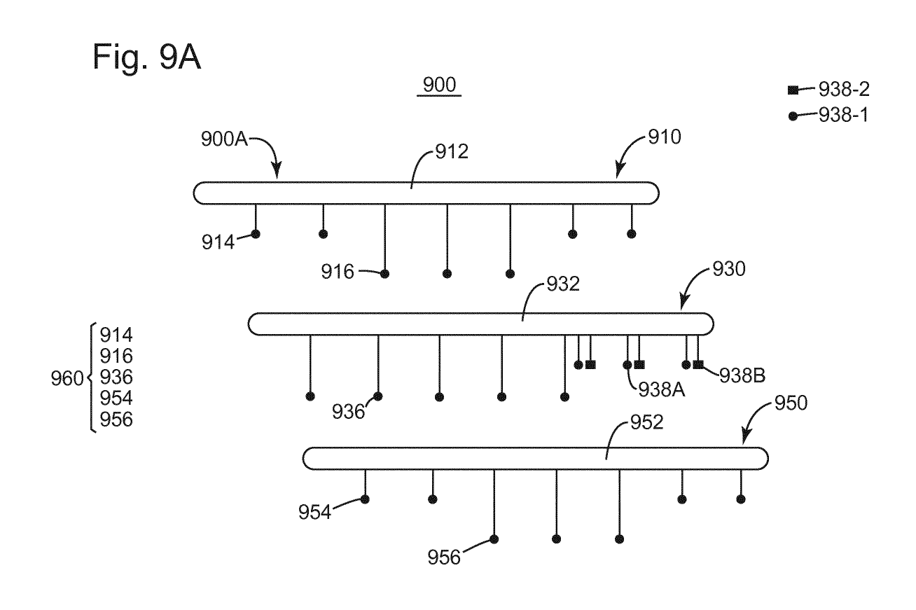

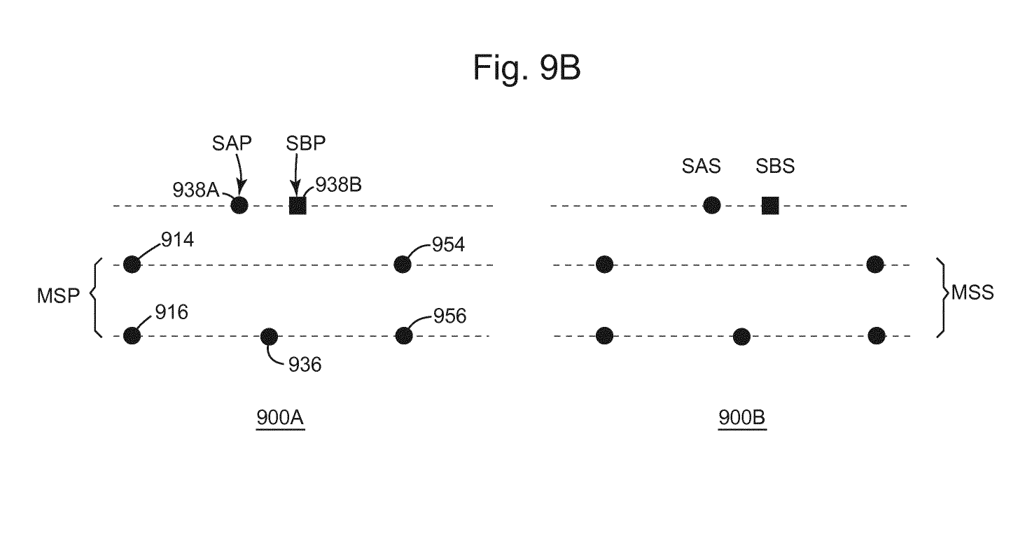

The above embodiments have been discussed without specifying what type of seismic source is used for generating the seismic signals and the reason for that is that any seismic source can be employed. However, if a multi-level source is used, as illustrated in FIG. 9A, same shallow air guns may be used to form a high-frequency source. More specifically, FIG. 9A shows a source array 900 including two source arrays 900A and 900B. Note that only source array 900A is visible in FIG. 9A. However, FIG. 9B shows both source arrays 900A and 900B. The structure of the two source arrays may be identical. Each of the source array includes three sub-arrays 910, 930 and 950. Each sub-array may include a float 912, or 932 or 952 and corresponding air guns. First and third sub-arrays 910 and 950 include a first set of air guns 914 and 954 distributed at a first depth, e.g., 6 m below the float, and a second set of air guns 916 and 956, distributed at a second depth, e.g., 9 m. The second (or middle) sub-array 930 includes a set of air guns 936, distributed at a same depth as air guns 916 and 956, and one or more sets of small source elements 938A and 938B, distributed at a third depth, e.g., 4 m. For simplicity, FIG. 9A shows only two sets of small source elements 938A and 938B (illustrated as circles and squares). These sets of source elements 938A and 938B form two high-frequency seismic source arrays 938-1 and 938-2. Those skilled in the art would recognize that the two high-frequency seismic source arrays 938-1 and -2 may be attached to other floats of the source array 900A or 900B. Also, those skilled in the art would recognize that the source array 900A or 900B may in fact include three different source arrays, the two high-frequency source arrays 938-1 and -2 and also the multi-level source 960 that includes source elements 914, 916, 936, 954, and 956. The number of high-frequency source arrays that are part of the source array 900A or 900B may vary. FIG. 9B shows a cross-sectional view of the source array 900. For simplicity, the multi-level source array on the port side of the towing vessel is called MSP, the shallow water high-frequency source array 938-1 on the port side is called SAP, the shallow water high-frequency source array 938-2 on the port side is called SBP, the multi-level source array on the starboard side of the towing vessel is called MSS, the shallow water high-frequency source array 938-1 on the starboard side is called SAS, and the shallow water high-frequency source array 938-2 on the starboard side is called SBS.

Because it is known to deblend signals corresponding to sources that are fired simultaneously or almost simultaneously (see, for example techniques described in U.S. Pat. No. 6,906,981, the entire content of which is incorporated herein by reference), it is possible to shoot the sets of sources forming the source array 900 in various ways, e.g., simultaneously, with a controlled time delay, in a flip-flop manner, etc. For example, considering that the sets of source elements 914, 916, 936, 954 and 956 are shot as a single source array 960 and the sets of source elements 938A and 938B are shot as single source arrays 938-1 and 938-2, both on the port and the starboard sides, the following pattern may be used to shoot all the source elements:

T1: MSP

T1+t1: SAS

T1+t1+ΔT1: SBS

T2: MSS

T2+t2: SAP

T2+t2+ΔT2: SBP

T3: MSP

T3+t3: SAS

T3+t3+ΔT3: SBS

T4: MSS

Tv+t4: SAP

T4+t4+ΔT4: SBP

where T1 to T4 are four successive time instants, t1, t2, t3, t4 are time delays and they may be positive of negative (e.g., close to half of the difference T2-T1), and ΔTi are small dithering values, for example, values of a pseudo-random sequence.

Another shooting pattern, that is believed to have a better illumination, is now illustrated as:

T1: MSP

T1+t1: SAS

T1+ΔT1: SBP

T2: MSS

T2+t2: SAP

T2+ΔT2: SBS

T3: MSP

T3+t3: SAS

T3+ΔT3: SBP

T4: MSS

T4+t4: SAP

T4+ΔT4: SBS

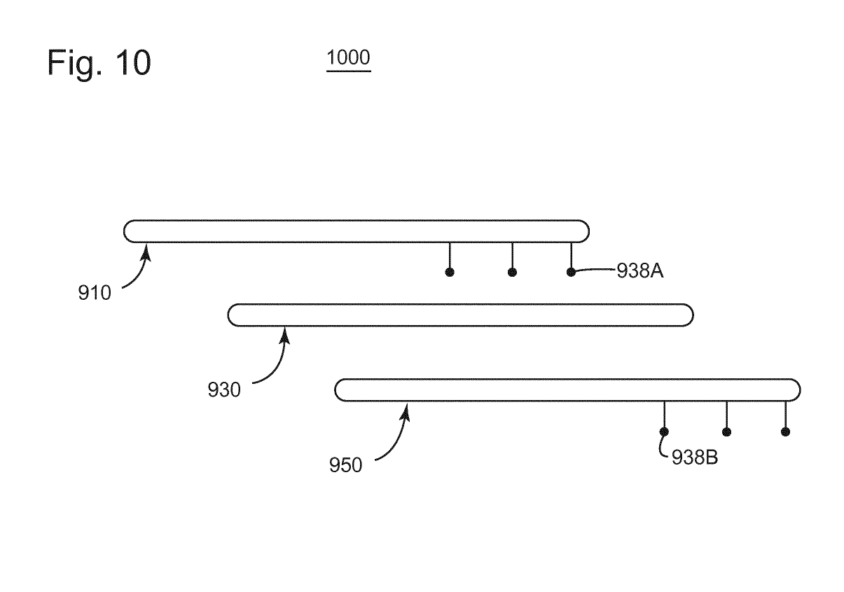

According to another embodiment illustrated in FIG. 10, the small source elements 938A and 938B may be separated from each other, for example, placed on the outer sub-arrays 910 and 950 instead on central sub-array 930, as illustrated in FIGS. 9A and B. The other source elements are not illustrated in FIG. 10 for simplicity, but they are similar to those shown in FIGS. 9A and B.

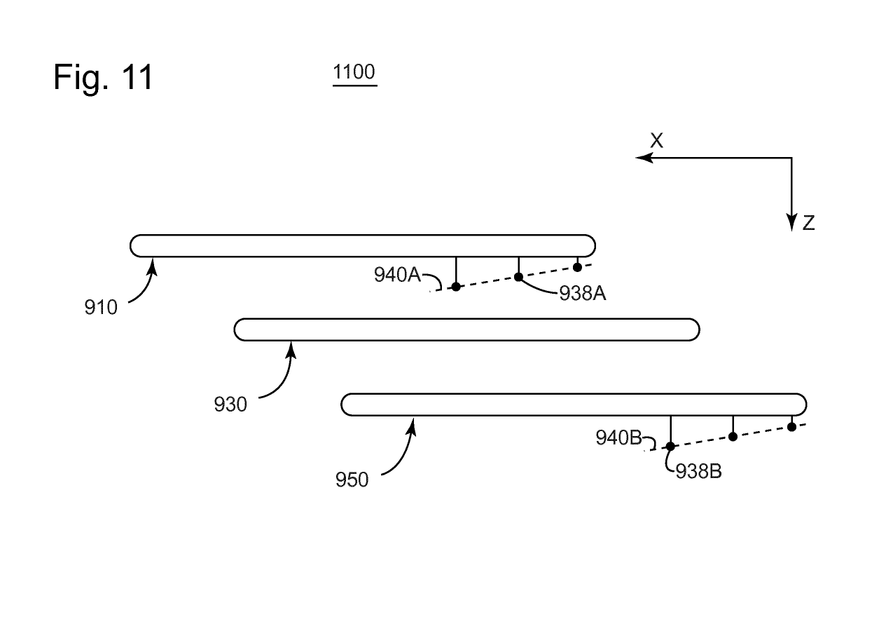

In still another embodiment illustrated in FIG. 11, the shallow source elements 938A and 938B may be tilted relative to the water surface, for sending more high-frequencies to the near offset, and/or use time delays. In one application, source elements 938A are distributed along a line 940A and source elements 938B are distributed along a line 940B. Each of the lines 940A and 940B may be tilted to the water surface (e.g., represented by axis X) with a given angle. The two angles may be the same or different.

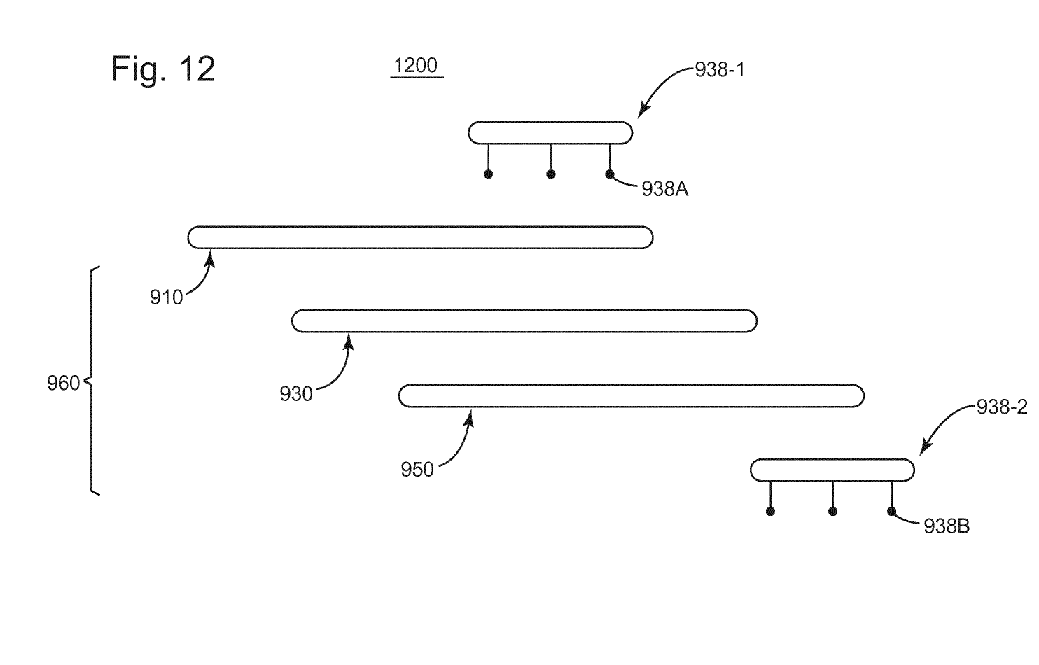

In still another embodiment, the source array 938-1, which includes source elements 938A, and the source array 938-2, which includes source elements 938B, may be placed outside the multi-level source array 960 (that includes elements 914, 916, 936, 954, and 956 as shown in FIGS. 9A and B) as illustrated in FIG. 12.

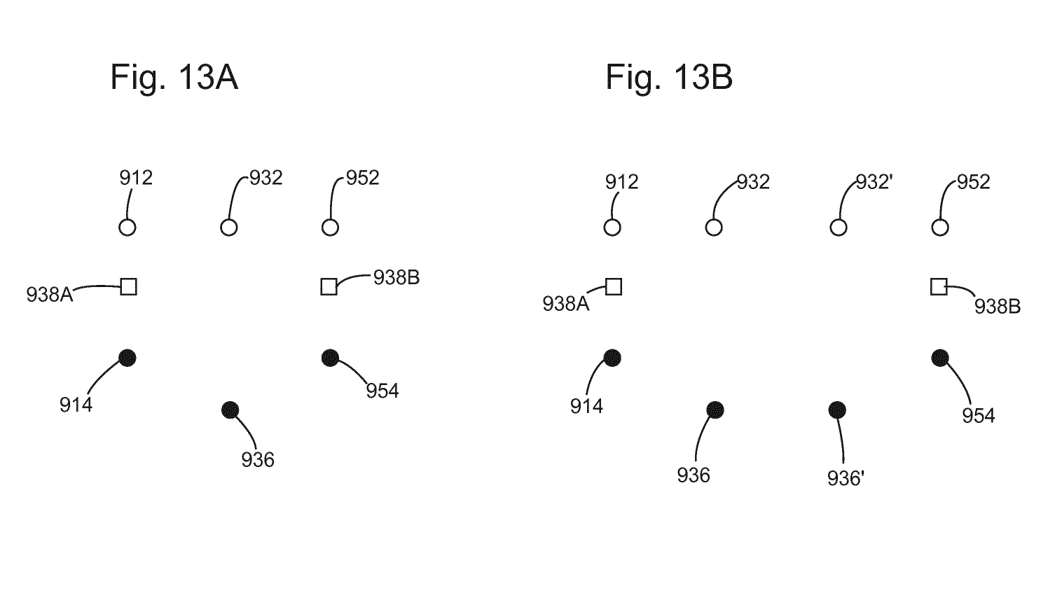

Various profiles may be designed for the source arrays 938-1, 938-2 and multi-source array 960. One such example is illustrated in FIG. 13A, in which the source elements of the multi-source array 960 form a V-shape. FIG. 13B illustrates another configuration having an extra float 932′ and an extra set of source elements 936′, similar to the set of source elements 936.

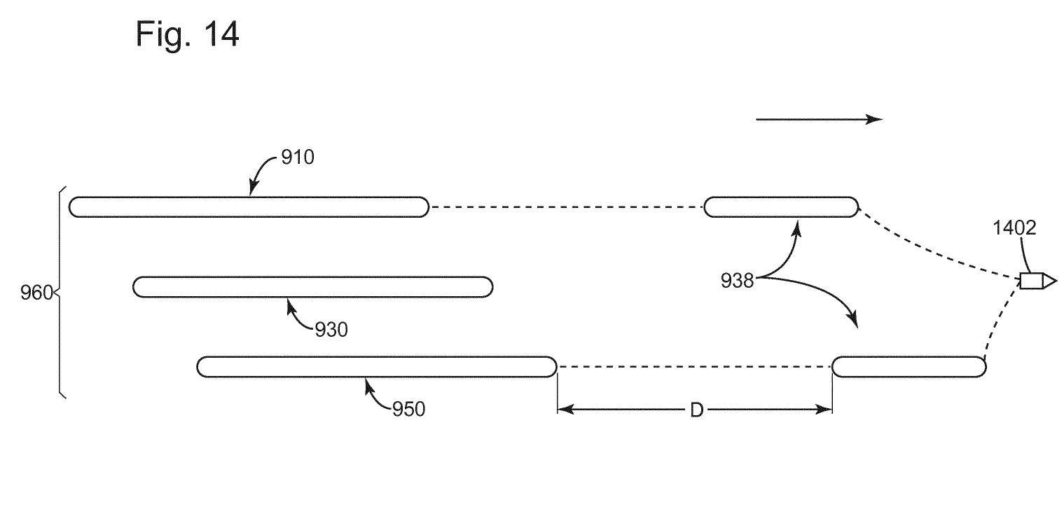

In still another embodiment illustrated in FIG. 14, the source arrays 938-1 and 938-2 may be moved away from the multi-level source array 960, for example, along the inline direction, so that the source arrays 938-1 and -2 are closer to the towing vessel 1402 than the multi-level source array 960. In other words, there is a predetermined distance D, along the inline direction X, between the two source arrays. This may be advantageous because only the near offset data represents the shallow part of the subsurface and the embodiment illustrated in FIG. 14 reduces the seismic offset between the source and the first trace. A variation of this embodiment would have the source arrays 938-1 and 938-2 configured as in FIG. 11, depending on the water depth, the geology of the subsurface, etc.

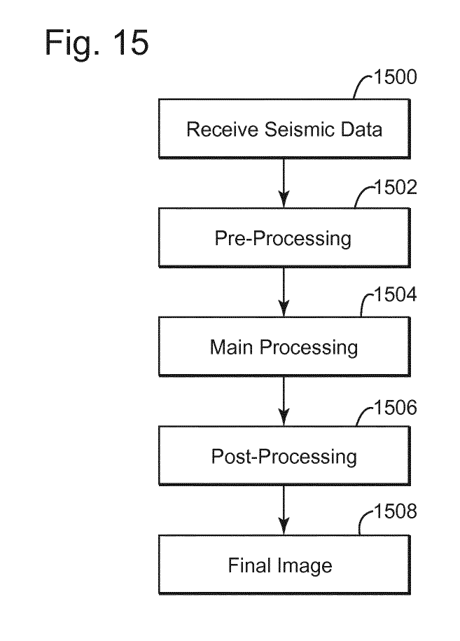

Seismic data generated by the seismic source arrays discussed above and acquired with the streamers also noted above may be processed in a corresponding processing device for generating a final image of the surveyed subsurface as discussed now with regard to FIG. 15. For example, the seismic data generated with the spreads as discussed with regard to FIGS. 2, 3A-C, 6 and 7 may be received in step 1500 at the processing device. In step 1502, pre-processing methods are applied, e.g., demultiple, signature deconvolution, trace summing, motion correction, vibroseis correlation, resampling, etc. In step 1504, the main processing takes place, e.g., deconvolution, amplitude analysis, statics determination, common middle point gathering, velocity analysis, normal-move out correction, muting, trace equalization, stacking, noise rejection, amplitude equalization, etc. In step 1506, final or post-processing methods are applied, e.g. migration, wavelet processing, seismic attribute estimation, inversion, etc. and in step 1508 the final image of the subsurface is generated.

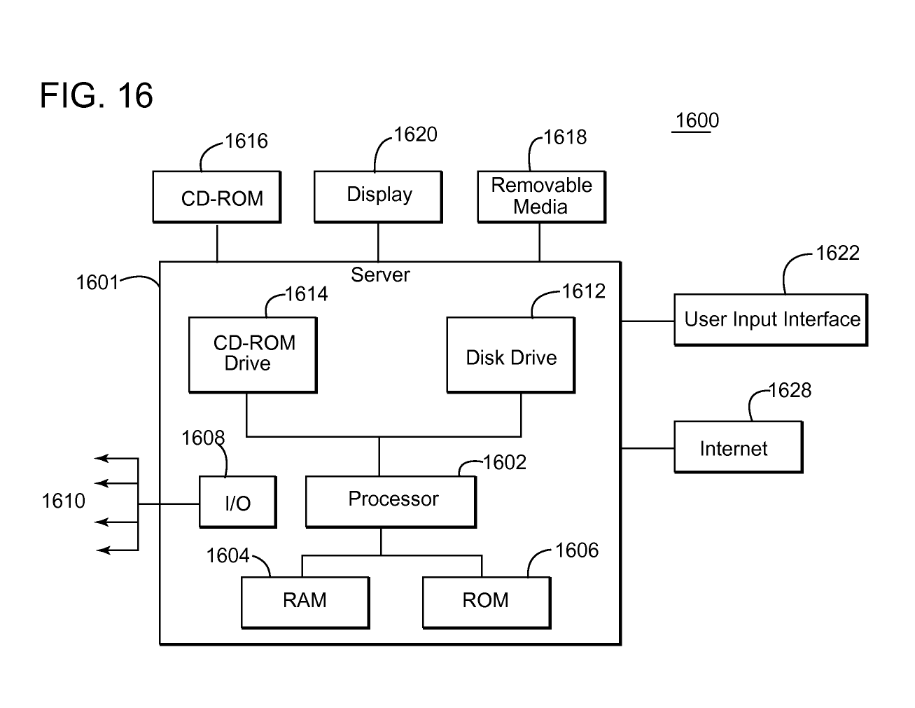

An example of a representative processing device capable of carrying out operations in accordance with the embodiments discussed above is illustrated in FIG. 16. Hardware, firmware, software or a combination thereof may be used to perform the various steps and operations described herein. The processing device 1600 of FIG. 16 is an exemplary computing structure that may implement any of the processes and methods discussed above or combinations of them.

The exemplary processing device 1600 suitable for performing the activities described in the exemplary embodiments may include server 1601. Such a server 1601 may include a central processor unit (CPU) 1602 coupled to a random access memory (RAM) 1604 and/or to a read-only memory (ROM) 1606. The ROM 1606 may also be other types of storage media to store programs, such as programmable ROM (PROM), erasable PROM (EPROM), etc. Processor 1602 may communicate with other internal and external components through input/output (I/O) circuitry 1608 and bussing 1610, to provide control signals and the like. For example, processor 1602 may communicate with the source arrays and each streamer and/or receiver. Processor 1602 carries out a variety of functions as are known in the art, as dictated by software and/or firmware instructions.

Server 1601 may also include one or more data storage devices, including disk drives 1612, CD-ROM drives 1614, and other hardware capable of reading and/or storing information, such as a DVD, etc. In one embodiment, software for carrying out the above-discussed steps may be stored and distributed on a CD-ROM 1616, removable media 1618 or other form of media capable of storing information. The storage media may be inserted into, and read by, devices such as the CD-ROM drive 1614, disk drive 1612, etc. Server 1601 may be coupled to a display 1620, which may be any type of known display or presentation screen, such as LCD, plasma displays, cathode ray tubes (CRT), etc. A user input interface 1622 is provided, including one or more user interface mechanisms such as a mouse, keyboard, microphone, touch pad, touch screen, voice-recognition system, etc.

Server 1601 may be coupled to other computing devices, such as the equipment of a vessel, via a network. The server may be part of a larger network configuration as in a global area network (GAN) such as the Internet 1628, which allows ultimate connection to the various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

The disclosed exemplary embodiments provide streamer spreads that can be configured to satisfy a large number of target seismic surveys. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A seismic acquisition system comprising:
a streamer spread including at least one streamer, the streamer spread having first and second spread areas characterized by at least one acquisition parameter,
the first spread area including streamer sections having a first composition of seismic receivers, and
the second spread area including streamer sections having a second composition of seismic receivers,
wherein the first composition of seismic receivers has a first value for the at least one acquisition parameter and the second composition of seismic receivers has a second value for the at least one acquisition parameter.

2. The system of claim 1, wherein the at least one acquisition parameter is a temporal sampling rate of seismic receivers in a corresponding area.

3. The system of claim 1, wherein the at least one acquisition parameter is at least one of a configuration of the seismic sensors in a corresponding area, a depth profile of the seismic sensors in a corresponding area, a type of seismic survey acquisition in a corresponding area, a spatial density of the seismic receivers in a corresponding area, or an offset of the seismic sensors in a corresponding area relative to a towing vessel, or a status of the seismic sensors in a corresponding area.

4. The system of claim 1, wherein the first composition of seismic receivers is configured to record high-frequency data and the second composition of seismic receivers is configured to record low-frequency data.

5. The system of claim 1, wherein the high-frequency data includes frequencies between 100 and 250 Hz and the low-frequency data includes frequencies lower than 35 Hz.

6. The system of claim 1, wherein a second acquisition parameter is one of a depth of the seismic sensors, or a distance from the seismic sensors to a towing vessel, or a distance from the seismic sensors to a seismic source, or a Fresnel zone for traces recorded within the first spread area, or a quality of the seismic data to be recorded, or a combination therein.

7. The system of claim 1, wherein the first composition of seismic receivers includes only multi-component sensors and the second composition of seismic receivers includes only pressure sensors.

8. The system of claim 1, wherein the first composition of seismic receivers includes multi-component sensors and pressure sensors and the second composition of seismic receivers include only pressure sensors.

9. A seismic acquisition system comprising:
a vessel; and
a streamer spread towed by the vessel and including at least one streamer, the streamer spread having first and second spread areas characterized by at least one acquisition parameter,
the first spread area including streamer sections having a first composition of seismic receivers, and
the second spread area including streamer sections having a second composition of seismic receivers,
wherein the first composition of seismic receivers has a first value for the at least one acquisition parameter and the second composition of seismic receivers has a second value for the at least one acquisition parameter.

10. The system of claim 9, wherein the at least one acquisition parameter is a temporal sampling rate of seismic receivers in a corresponding area.

11. The system of claim 9, wherein the at least one acquisition parameter is at least one of a configuration of the seismic sensors in a corresponding area, a depth profile of the seismic sensors in a corresponding area, a type of seismic survey acquisition in a corresponding area, a spatial density of the seismic receivers in a corresponding area, or an offset of the seismic sensors in a corresponding area relative to a towing vessel, or a status of the seismic sensors in a corresponding area.

12. The system of claim 9, wherein the first composition of seismic receivers includes multi-component sensors and pressure sensors and the second composition of seismic receivers include only pressure sensors.

13. A method for acquiring seismic data, the method comprising:
defining a first spread area of a streamer spread including at least one streamer, wherein the first spread area is characterized by at least one acquisition parameter having a first value;
defining a second spread area of the streamer spread, wherein the second spread area is characterized by the at least one acquisition parameter having a second value;
selecting streamer sections having a first composition of seismic receivers for the first spread area and streamer sections having a second composition of seismic receivers for the second spread area based on a corresponding value of the at least one acquisition parameter;
generating seismic waves; and
recording with the first and second composition of seismic receivers seismic data.

14. The method of claim 13, wherein the at least one acquisition parameter is a temporal sampling rate of seismic receivers in a corresponding area.

15. The method of claim 13, wherein the at least one acquisition parameter is at least one of a configuration of the seismic sensors in a corresponding area, a depth profile of the seismic sensors in a corresponding area, a type of seismic survey acquisition in a corresponding area, a spatial density of the seismic receivers in a corresponding area, or an offset of the seismic sensors in a corresponding area relative to a towing vessel, or a status of the seismic sensors in a corresponding area.

16. The method of claim 13, wherein the first composition of seismic receivers is configured to record high-frequency data and the second composition of seismic receivers is configured to record low-frequency data.

17. The method of claim 16, wherein the high-frequency data includes frequencies between 100 and 250 Hz and the low-frequency data includes frequencies lower than 35 Hz.

18. The method of claim 13, wherein a second acquisition parameter is one of a depth of the seismic sensors, or a distance from the seismic sensors to a towing vessel, or a distance from the seismic sensors to a seismic source, or a Fresnel zone for traces recorded within the first spread area, or a quality of the seismic data to be recorded, or a combination therein.

19. The method of claim 13, wherein the first composition of seismic receivers includes only multi-component sensors and the second composition of seismic receivers includes only pressure sensors.

20. The method of claim 13, wherein the first composition of seismic receivers includes multi-component sensors and pressure sensors and the second composition of seismic receivers include only pressure sensors.
